(19) United States
(12) Patent Application Publication
(10) Pub. No.: US 2015/0187294 A1
(43) Pub. Date: Jul. 2, 2015

(54) DISPLAY PANEL ASSEMBLY, METHOD FOR ADJUSTING THE DISPLAY PANEL ASSEMBLY, AND DISPLAY DEVICE

(71) Applicant: SHENZHEN CHINA STAR OPTOELECTRONICS TECHNOLOGH CO. LTD., Shenzhen, Guangdong (CN)

(72) Inventors: Yuyeh Chen, Shenzhen (CN); Yin-hung Chen, Shenzhen (CN); Dongsheng Guo, Shenzhen (CN)

(21) Appl. No.: 14/235,078

(22) PCT Filed: Jan. 10, 2014
(86) PCT No.: PCT/CN2014/070435

§ 371 Date: Jan. 26, 2014

(30) Foreign Application Priority Data
Dec. 31, 2013 (CN) 201310750374.0

(51) Int. Cl. G09G 3/36

(52) U.S. Cl. CPC G09G 3/3611; G09G 2300/04

(57) ABSTRACT

A display panel assembly includes a display panel including a display area and a fanout area, a driving circuit including a function circuit and an adjustable resistor group connected to an output end of the function circuit, and a control circuit that controls a resistance of the adjustable resistor group. The display area is configured with a plurality of first data lines, and the fanout area is configured with a plurality of second data lines having different lengths and connecting with the first data line. The second data line is coupled to the output end of the function circuit through the adjustable resistor group, the adjustable resistor group reduces an impedance of a data line between the output end of the function circuit and the first data line.

### TECHNICAL FIELD

The present disclosure relates to display devices, and more particularly to a display panel assembly, a method for adjusting the display panel assembly, and a display device.

### BACKGROUND

As shown in FIG. 1, a typical liquid crystal display (LCD) panel assembly includes a display panel 100, a display area 110 arranged on the display panel 100, a fanout area 120 arranged on the display panel 100, a chip-on-film (COF) 130 with a driving integrated chip (IC) 140 arranged at an edge of the display panel 100, and a printed circuit board (PCB) 150. The display area 110 is configured with a plurality of first data lines 111, the fanout area 120 is configured with a plurality of second data lines 121 connecting with the first data line 111, and the COF 130 is configured with a plurality of third data lines 131 interconnecting the plurality of second data lines 121 and the driving IC 140. As shown in FIG. 1, a plurality of junction points are formed between the plurality of second data lines 121 and the plurality of the first data lines 111. Distances between different junction points and the driving IC 140 are different, which results in different lengths of second data lines 121, thus, impedances of the plurality of second data lines 121 are different. The impedance causes a signal delay, as the length of the second data line 121 increases, the impedance of the second data line correspondingly increases, and a degree of a signal distortion correspondingly increases. Thus, some defects are displayed, such as luminance difference of different areas of the display panel, color cast, and the like. This problem is especially true for large sized LCD panels, where integration of the driving IC is improved, and where a number of the driving IC used in the LCD panel is less, the above-mentioned defects are more serious.

As shown in FIG. 2, in order to solve the above-mentioned defects, the typical LCD panel is configured with a coiling in the fanout area for coiling compensation, namely the coiling is arranged in the second data line 121 that is short to increase the length of the short second data line 121. The coiling is formed through arranging a winding portion 122, as the length of the second data line 121 increases, a number of the coiling correspondingly reduces. The above-mentioned method increases a size of the fanout area of the LCD panel, which is not good for controlling costs of the display panel and narrowing frame of the display panel.

### SUMMARY

The aim of the present disclosure is to provide a display panel assembly, a method for adjusting the display panel assembly, and a display device having a narrow frame and good display quality.

The aim of the present disclosure is achieved by the following methods.

A display panel assembly comprises a display panel comprising a display area and a fanout area, a driving circuit comprising a function circuit and an adjustable resistor group connected to an output end of the function circuit, and a control circuit controlling a resistance of the adjustable resistor group. The display area is configured with a plurality of first data lines, and the fanout area is configure with a plurality of second data lines having different lengths and connecting with the first data line. The second data line is coupled to the output end of the function circuit through the adjustable resistor group, and the adjustable resistor group is used for reducing an impedance of a data line between the output end of the function circuit and the first data line.

Furthermore, the function circuit and the adjustable resistor group connected to the output end of the function circuit are integrated in one driving integrated chip (IC), which obtains high integration level and reduces costs.

Furthermore, the display panel assembly further comprises a chip-on-film arranged at an edge of the fanout area of the display panel, and the driving IC is arranged on the chip-on-film.

Furthermore, the driving IC is integrated in a glass substrate of the display panel, which reduces a volume of the LCD assembly.

Furthermore, the control circuit comprises a writing pin for writing data, the control circuit obtains a control signal of a preset resistance of the adjustable resistor group through the writing pin, and the control circuit adjusts the adjustable resistor group through the control signal.

Furthermore, the control circuit is integrated in the driving IC, and the writing pin is arranged on the driving IC, which has high integration level, reduces accessory and product costs.

Furthermore, the adjustable resistor group is a digital resistor group, and the control circuit is a digital control circuit. The digital resistor group and digital control circuit can easily obtain a control adjustment, and the cost is low.

Furthermore, a plurality of resistance values is preset for the adjustable resistor group to correspond to different types of display panel, which obtains simple control method. The resistance of the adjustable resistor group is obtained through the corresponding control signal, the component is easily obtained, and the costs are low.

A method for adjusting a display panel assembly, the display panel assembly comprising a display panel that comprises a display area and a fanout area, and a driving circuit that comprises a function circuit and an adjustable resistor group connected to an output end of the function circuit. The display area configured with a plurality of first data lines, and the fanout area configured with a plurality of second data lines having different lengths and connecting with the first data line. The second data line is coupled to the output end of the function circuit through the adjustable resistor group. The method comprises following steps:

S1: adjusting a resistance of the adjustable resistor group to reduce an impedance difference of a data line between the output end of the function circuit and the first data line.

Furthermore, the control circuit comprises a writing pin for writing data. In the step S1, the control circuit reads a corresponding control signal from a data signal through the writing pin, and analyzes the control signal to obtain the resistance of the adjustable resistor group corresponding to the display panel assembly, the control circuit automatically and controllably adjusts the adjustable resistor group, which does not need to modify a timing controller (TCON), thereby reducing the produce costs.

The present disclosure reduces the impedance of the data line between the output end of the function circuit of the driving circuit and the first data line through the adjustable resistor group, and controls the adjustable resistor group through the control circuit, which avoids great difference of the signal delay between the data lines. Thus, the display panel obtains even color and brightness. Because the adjustable resistor group is arranged at the display panel, the length of the second data line of the fanout area of the panel is not needed to be increased, and the second data line of the fanout area of the panel is paved in the straight line, which reduces a height of the fanout area, thus, the LCD device obtains the narrow frame. Because the resistance of the adjustable resistor can be adjusted, each type of panel does not need to be configured with one corresponding driving IC or resistor. When other type of panel is used, only the resistance of the adjustable resistor group is adjusted, which reduces the product costs and improves production efficiency.

### BRIEF DESCRIPTION OF FIGURES

FIG. 1 is a structural diagram of a first typical liquid crystal display (LCD) panel assembly.

FIG. 2 is a structural diagram of a fanout area of a second typical LCD panel.

FIG. 3 is a structural diagram of an LCD panel assembly of a first example of the present disclosure.

FIG. 4 is a structural diagram of a chip-on-film (COF) of an LCD panel assembly of a third example of the present disclosure.

FIG. 5 is a structural diagram of an LCD panel assembly of a fourth example of the present disclosure.

FIG. 6 is a cross-sectional view of a third data line of an LCD panel assembly of a fifth example of the present disclosure.

FIG. 7 is a cross-sectional view of a third data line of an LCD panel assembly of a sixth example of the present disclosure.

FIG. 8 is a cross-sectional view of a third data line of an LCD panel assembly of a seventh example of the present disclosure.

FIG. 9 is a structural diagram of a COF of an LCD panel assembly of an eighth example of the present disclosure.

FIG. 10 is a flowchart of a method for adjusting an LCD panel assembly of a first example of the present disclosure.

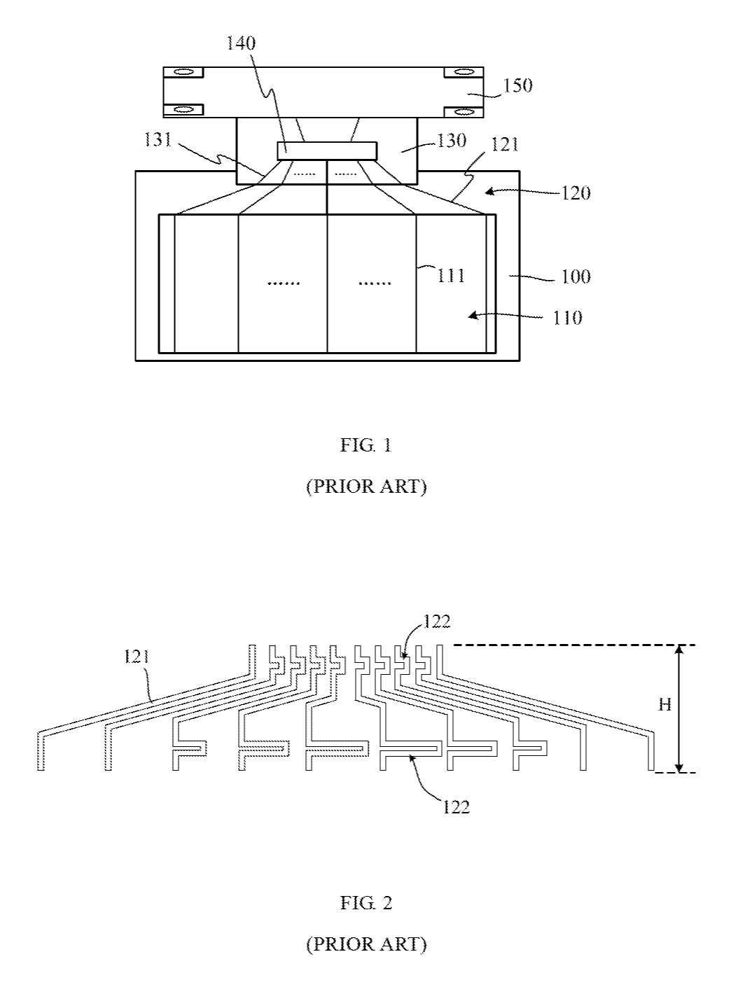

### DETAILED DESCRIPTION

The present disclosure will further be described in detail in accordance with the figures and the exemplary examples.

In following examples, a liquid crystal display (LCD) panel assembly having one driving integrated chip (IC) is used as an example; however, the present disclosure is not limited to the LCD panel assembly having one driving IC, and the present disclosure is also used for an LCD device having a plurality of driving ICs.

### Example 1

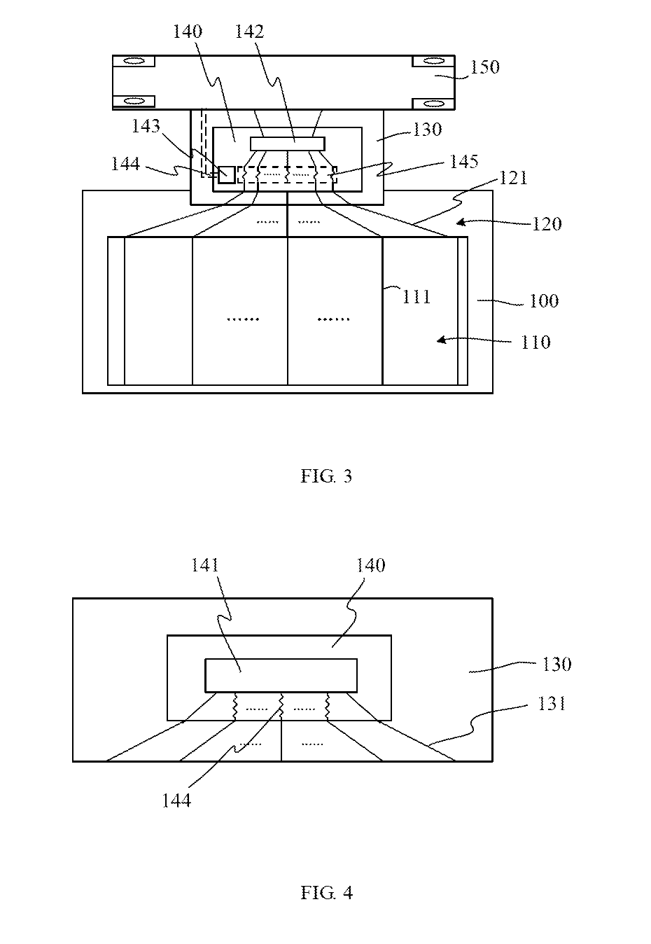

As shown in FIG. 3, a first example provides a liquid crystal display (LCD) panel assembly comprising a display panel 100, a display area 110 arranged on the display panel 100, a fanout area 120 arranged on the display panel 100, a chip-on-film (COF) 130 with a driving integrated chip (IC) 140 arranged at an edge of the display panel 100, and a printed circuit broad (PCB) 150.

The display area 110 is configured with a plurality of first data lines 111, and the fanout area 120 is configured with a plurality of second data lines 121 connecting with the first data line 111. A length of the second data line 121 is determined by a distance between the first data line 111 and the driving IC 140, as the distance between the first data line 111 and the driving IC 140 increases, the length of the second data line 121 increases. The second data line 121 is a straight line, which reduces a width of the edge of the display panel 100 as far as possible to obtain a narrow frame of the display device. The COF 130 interconnects the display panel 100 and the PCB 150, and the driving IC 140 is packaged in the COF 130. A function circuit 142, an adjustable resistor group 145, and a control circuit 143 controlling the adjustable resistor group 145 are integrated in the driving IC 140. A writing pin 44 of the control circuit 143 is arranged at the driving IC 140. The second data line 121 is coupled to an output end of the function circuit 142 of the driving IC 140 through the adjustable resistor group 145. The control circuit 143 controls the adjustable resistor group 145 to adjust a resistance of each of resistors in the adjustable resistor group, which reduces an impedance difference of a data line between the output end of the function circuit 142 and the first data line 111, and avoids luminance and color difference between the different display areas of the display LCD 100 due to a signal delay caused by large impedance differences between the data lines.

In the first example, the adjustable resistor group 145 is an adjustable digital resistor group, and the control circuit 143 is a digital control circuit. The digital resistor is a precise adjustable resistor, and the digital control circuit employs a simple control method. A plurality of adjustable resistors is arranged in the adjustable resistor group, thus, it is complicated to adjust each of the adjustable resistors. In the first example, multiple sets of resistance values of the adjustable resistor group 145 are preset according to a model of the display panel (e.g. a big display panel, a middle display panel, and a small display panel), the control circuit 143 only chooses a set of resistance value from the preset multiple sets of resistance values as the resistance of the adjustable resistor group according to the model of the display panel. The control circuit 143 comprises the writing pin 144 for writing data, and obtains a control signal of the preset resistance value of the adjustable resistor group 145 through the writing pin to adjust the adjustable resistor group 145. Using four types of display panel as an example, the resistance values of the adjustable resistor groups of the four types of display panel are preset, when one of four types of display panel is used, the control circuit chooses one of four preset resistance values as the resistance of the adjustable resistor group according to the type of the display panel. The above-mentioned method simplifies the control of the control circuit, the four preset resistance values can be chosen and controlled through two writing pins (00, 01, 10, and 11), thus, the control circuit can control the adjustable resistor group only through the control signal, the control method is simple, components are easily obtained, and costs are low. Data written by the writing pin are integrated in a redundant digital position of the data signal, the control circuit 143 monitors the data signal of a corresponding port, which can automatically and controllably choose the resistance of the adjustable resistor group, thus, the PCB 150 (timing controller TCON) is not changed, thereby reducing costs and improving use of the COF 130.

It should be understood that the control circuit 143 and the adjustable resistor group 145 may be integrated on the COF 130, or another IC comprising the control circuit 143 and the adjustable resistor group 145 is formed.

The example also provides a method for controlling the above-mentioned display panel assembly, as shown in FIG. 10, the method comprises following steps:

S0: obtaining the control signal corresponding to the resistance of the adjustable resistor group from the redundant digital position of the data signal; and
S1: analyzing the control signal and adjusting the resistance of the adjustable resistor group by the control circuit to reduce the impedance difference of the data line between the output end of the function circuit and the first data line.

### Example 2

A second example is improved on a basis of the first example, the adjustable resistor group 145 is divided into a plurality of sub-adjustable resistor groups. The resistances of the adjustable resistors in one sub-adjustable resistor group are same, thus, each of output ends of the function circuit does not need to be connected to the resistors having different resistances, and one group of resistor having the same resistance is needed to reduce the impedance difference of the data line between the output end of the function circuit and the first data line 111. The LCD panel assembly of the second example allows the signal delay to be reduced, has a small influence to the display quality, and reduces costs.

### Example 3

As shown in FIG. 4, a difference between a third example and the first example is that a resistor 144 is directly integrated in the driving IC 140, the third data line 131 is coupled to the output end of the driving IC 140 through the resistor 144, and the third data line 131 is connected to the second data line 121 of the fanout area, which does not need to arrange a control circuit to control the resistor, but the driving IC of the third example only is used in one type of panel. It should be considered that a plurality of resistors having same resistance could be combined to form one resistor group, and a plurality of resistor groups having different resistance can be integrated in the driving IC 140. Thus, each of output ends of the driving IC 140 does not need to be connected to the resistors having different resistances, and one group of resistor having the same resistance is needed to reduce the impedance difference. The LCD panel assembly of the third example allows the signal delay to be reduced, has the small influence to the display quality, and reduces costs.

In the first, second, and third examples, the driving IC 140 is integrated in the COF 130, it should be understood that the driving IC 140 can be integrated in a glass substrate of the display panel 100 to form a panel having a chip on glass (COG) structure, the panel having the COG structure can reduce size of the LCD assembly.

### Example 4

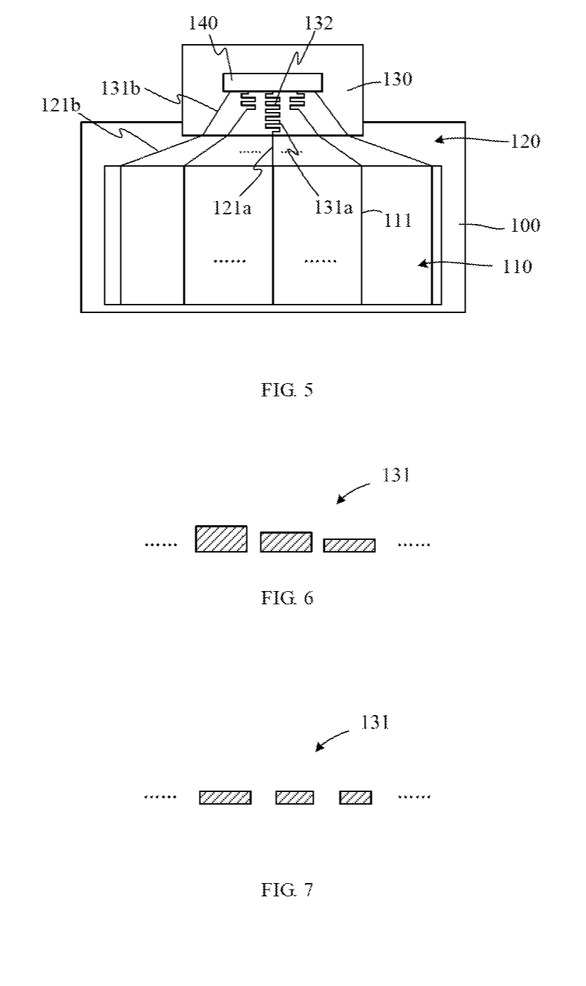

As shown in FIG. 5, a fourth example provides an LCD display panel assembly comprising the display panel 100, the display area 110 arranged on the display panel 100, the fanout area 120 arranged on the display panel 100, the COF 130 with the driving IC 140 arranged at the edge of the display panel 100, and the PCB.

The display area 110 is configured with the plurality of first data lines 111, and the fanout area 120 is configured with the plurality of second data lines 121 having different lengths and connecting with the first data line 111. The length of the second data line 121 is determined by the distance between the first data line 111 and the driving IC 140, as the distance between the first data line 111 and the driving IC 140 increases, the length of the second data line 121 increases. The second data line 121 is paved in the straight line. Using a shortest second data line 121a connected to a center of the driving IC 140 as an example, a length of the second data line 121a is far less than a length of the second data line 121b connected to two sides of the driving IC 140.

The COF 130 is configured with the plurality of third data lines 131 to connect the second data line 121 with the driving IC 140. Some of the third data lines 131 are configured with one or a plurality of bending portions 132, the bending portion 132 increases the length of the third data line 131. As the length of the second data line 121 connected the third data line 131 reduces, a number of the bending portion arranged in the corresponding third data line 131 increases, thus, the impedance of the corresponding data line increases. Using the third data line 131a connected to the second data line 121a as an example, because the impedance of the third data line 131a is great, an impedance of the data line comprising the third data line 131a and the second data line 121a is great, thus, the impedance difference between the data line comprising the third data line 131a and the second data line 121a and a data line comprising the third data line 131b and the second data line 121b is small.

The fourth example increases the lengths of some of the third data lines 131 to reduce the impedance difference between the data lines comprising the second data line 121 and the third data line 131, the data line from the output end of the driving IC 140 to the first data line 111 is correspondingly increased, which avoids great difference of the signal delay between the data lines. Thus, the display panel obtains even color and brightness. Because the bending portion is arranged on the COF 130, the length of the second data line 121 of the fanout area of the panel does not need to be increased, and the second data line of the fanout area of the panel is in a straight line, which reduces height of the fanout area, thus, the LCD device can have a narrow frame.

### Example 5

As shown in FIG. 6, in a fifth example, the impedance difference between the data lines can be reduced through using different thickness of third data lines 131. As the thickness of the third data line 131 increases, the impedance of the third data line 131 reduces, thus, the third data line 131 having a great thickness is arranged at two sides of the driving IC.

### Example 6

As shown in FIG. 7, in a sixth example, the impedance difference between the data lines can be reduced through using different width of third data lines 131. As the width of the third data line 131 increases, the impedance of the third data line 131 reduces, thus, the third data line 131 having a great width is arranged at two sides of the driving IC.

### Example 7

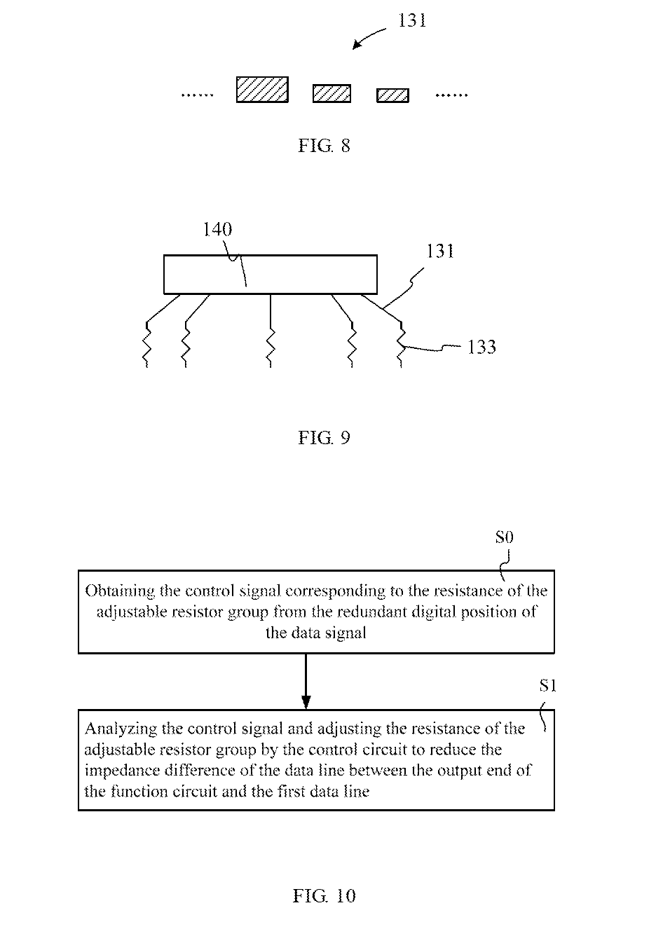

As shown in FIG. 8, a seventh example combines the width of the third data line, the thickness of the third data line, and the bending portion to reduce the impedance difference between the data lines. Namely when the bending portion is arranged, the width and thickness of the third data line are also adjusted, which reduces a region of the third data line 131 in the COF 130.

### Example 8

As shown in FIG. 9, in an eighth example, a plurality of resistors 133 are integrated in the COF, an impedance between the plurality of resistors 133 is different, and the plurality of resistors 133 are respectively connected to the output end of the driving IC 140, the third data line 131 is coupled to the driving IC 140 through the resistor 133.

The present disclosure is described in detail in accordance with the above contents with the specific exemplary examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A display panel assembly, comprising:
a display panel comprising a display area and a fanout area;
a driving circuit comprising a function circuit and an adjustable resistor group connected to an output end of the function circuit; and
a control circuit that controls a resistance of the adjustable resistor group;
wherein the display area is configured with a plurality of first data lines, and the fanout area is configured with a plurality of second data lines having different lengths and connecting with the first data line; the second data line is coupled to the output end of the function circuit through the adjustable resistor group, the adjustable resistor group reduces an impedance of a data line between the output end of the function circuit and the first data line.

2. The display panel assembly of claim 1, wherein the function circuit and the adjustable resistor group connected to the output end of the function circuit are integrated in one driving integrated chip (IC).

3. The display panel assembly of claim 2, further comprising a chip-on-film arranged at an edge of the fanout area of the display panel, and the driving IC is arranged on the chip-on-film.

4. The display panel assembly of claim 2, wherein the driving IC is integrated in a glass substrate of the display panel.

5. The display panel assembly of claim 2, wherein the control circuit comprises a writing pin for writing data, the control circuit obtains a control signal of a preset resistance of the adjustable resistor group through the writing pin, and the control circuit adjusts the adjustable resistor group through the control signal.

6. The display panel assembly of claim 5, wherein the control circuit is integrated in the driving IC, and the writing pin is arranged on the driving IC.

7. The display panel assembly of claim 1, wherein the adjustable resistor group is a digital resistor group, and the control circuit is a digital control circuit.

8. The display panel assembly of claim 1, wherein a plurality of resistance values are preset for the adjustable resistor group to correspond to different types of display panel.

9. A liquid crystal display (LCD) device, comprising:
a display panel comprising a display area and a fanout area;
a driving circuit comprising a function circuit and an adjustable resistor group connected to an output end of the function circuit; and
a control circuit that controls a resistance of the adjustable resistor group:
wherein the display area is configured with a plurality of first data lines, and the fanout area is configured with a plurality of second data lines having different lengths and connecting with the first data line; the second data line is coupled to the output end of the function circuit through the adjustable resistor group, the adjustable resistor group reduces an impedance of a data line between the output end of the function circuit and the first data line.

10. The LCD device of claim 9, wherein the function circuit and the adjustable resistor group connected to the output end of the function circuit are integrated in one driving integrated chip (IC).

11. The LCD device of claim 10, further comprising a chip-on-film arranged at an edge of the fanout area of the display panel, and the driving IC is arranged on the chip-on-film.

12. The LCD device of claim 10, wherein the driving IC is integrated in a glass substrate of the display panel.

13. The LCD device of claim 10, wherein the control circuit comprises a writing pin for writing data, the control circuit obtains a control signal of a preset resistance of the adjustable resistor group through the writing pin, and the control circuit adjusts the adjustable resistor group through the control signal.

14. The LCD device of claim 13, wherein the control circuit is integrated in the driving IC, and the writing pin is arranged on the driving IC.

15. The LCD device of claim 9, wherein the adjustable resistor group is a digital resistor group, and the control circuit is a digital control circuit.

16. The LCD device of claim 9, wherein a plurality of resistance values are preset for the adjustable resistor group to correspond to different types of display panel.

17. A method for adjusting a display panel assembly, the display panel assembly comprising a display panel that comprises a display area and a fanout area, and a driving circuit that comprises a function circuit and an adjustable resistor group connected to an output end of the function circuit; the display area configured with a plurality of first data lines, and the fanout area configured with a plurality of second data lines having different lengths and connected with the first data line; the second data line coupled to the output end of the function circuit through the adjustable resistor group; the method comprising:
S1: adjusting a resistance of the adjustable resistor group to reduce an impedance difference of a data line between the output end of the function circuit and the first data line.

18. The method for adjusting the display panel assembly of claim 17, wherein the control circuit comprises a writing pin for writing data; in the step S1, the control circuit reads a corresponding control signal from a data signal through the writing pin, and analyzes the control signal to obtain the resistance of the adjustable resistor group corresponding to the display panel assembly, the control circuit automatically and controllably adjusts the adjustable resistor group.
